(19) United States
(12) Patent Application Publication
(10) Pub. No.: US 2013/0138532 A1
(43) Pub. Date: May 30, 2013

(54) METHOD AND SYSTEM FOR UPSELLING TO A USER OF A DIGITAL BOOK LENDING LIBRARY

(71) Applicants: Ronald DICKE, Ottawa (CA); Gordon FREEDMAN, Ottawa (CA)

(72) Inventors: Ronald DICKE, Ottawa (CA); Gordon FREEDMAN, Ottawa (CA)

(21) Appl. No.: 13/744,670

(22) Filed: Jan. 18, 2013

Related U.S. Application Data
(63) Continuation-in-part of application No. 13/160,839, filed on Jun. 15, 2011, now Pat. No. 8,380,632.
Application No. 13/160,839 is a continuation-in-part of application No. 13/160,948, filed on Jun. 15, 2011, now Pat. No. 8,380,633.
(60) Provisional application No. 61/355,258, filed on Jun. 16, 2010.
(60) Provisional application No. 61/355,286, filed on Jun. 16, 2010.

(51) Int. Cl. G06Q 30/06

(52) U.S. Cl. CPC G06Q 30/0631
USPC 705/26.7

(57) ABSTRACT

A method is disclosed where an e-book lending library is provided. The lending library includes data relating to one of license data relating to a plurality of e-books and a plurality of e-books. A request to borrow a first e-book of the plurality of e-books for a predetermined finite period of time is received at the e-book lending library. A current lending status of the first e-book is determined as one of available for lending and unavailable for lending. When it is determined that the first e-book is unavailable for lending, a second signal is transmitted to the user via the communication network, the second signal comprising an offer to sell to the user the first e-book via the e-book lending library.

### FIELD OF THE INVENTION

The instant invention relates generally to digital books or e-books, and more particularly to a system and method for upselling to a user of a digital book lending library.

### BACKGROUND OF THE INVENTION

A digital book, which is also known as an electronic book or an e-book, is the digital media equivalent of a conventional printed book. Typically, digital books are structured as virtual frames presented on a display device. During a reading session a user may turn or change from one virtual frame or “page” to another. Advantageously, the “pages” are not fixed permanently, and may be redefined or repaginated based on variances in display conditions, such as screen size, font type or size, margins, line spacing, resolution, etc.

Conveniently, digital books may be read on personal computers, personal digital assistants (PDAs), smart phones, etc., or on dedicated hardware devices known as e-book readers or e-book devices. Another convenience that is associated with digital books is the ability to purchase and download, or download and store, a reading selection directly from a digital library or commercial site. Some e-book readers, such as for instance Amazon's Kindle 2, use a 3G wireless network to allow the user to download digital books directly to the device, even if a Wi-Fi hotspot is not available. Other devices that can be “repurposed” for reading digital books, such as for instance Apple's IPod Touch, achieve similar functionality using a local wireless network connection.

Digital books currently offer several advantages over conventional printed books. For instance: text can be searched automatically and cross-referenced using hyperlinks; font size and font type can be customized; non-permanent highlighting and annotation is supported; animated images or multimedia clips are supported; reading can resume automatically at the last read page, etc. In addition, a single e-book reader containing the text of several digital books is easier to carry around than the same books in printed form. Furthermore, the backlit display of an e-book reader allows reading in low light, or even in total darkness.

Of course, lending libraries of digital books are known. For instance, many public libraries currently allow registered patrons to borrow digital books via a library webpage. In this type of system the patron typically borrows a digital book from the lending library for a predetermined finite period of time, such as for instance 21 days, after which time the digital book is returned automatically to the digital book lending library. In practice, the digital book is made available for being displayed to the patron during the predetermined finite period of time, such as for instance via an electronic device that is associated with the patron. Once the predetermined finite period of time has elapsed the digital book is no longer accessible using the electronic device, unless of course the patron “renews” the loan. Advantageously, digital libraries offer their patrons the convenience of being able to borrow digital books at any time, usually twenty-four hours a day and seven days a week, without having to ever enter a physical branch of the library. In addition, patrons do not need to be concerned about incurring late return fees, since the digital books are returned automatically at the end of the loan period.

A digital book lending library also shares some features in common with traditional bricks-and-mortar libraries. For example, when one patron is using a license that is associated with a digital book, then that digital book is not available for being loaned to any other patron until after it has been “returned.” Instead, when another patron requests the digital book they may be offered the option of placing a “hold” on the requested digital book. At some later time the patron that placed the hold is notified that the requested digital book has become available, at which time that patron either may “check-out” the digital book or release the hold if they no longer require the digital book. It is therefore a disadvantage that digital book lending libraries currently offer only a limited number of copies of each digital book for being loaned during any particular period of time. The need to place a “hold” when a requested digital book is unavailable diminishes the convenience that is normally associated with digital book lending libraries, and may cause patrons simply to forgo reading certain digital books. Furthermore, it is a disadvantage that a patron may not be able to renew the loan of a digital book if another patron has placed a “hold.” In particular, the digital book may be returned automatically at the end of a current loan period, even if the patron has not finished reading the book. In this case, the patron either must wait until the book becomes available again or simply miss reading the rest of the book.

It would be advantageous to provide a system and method that overcomes at least some of the above-mentioned limitations of the prior art.

### SUMMARY OF EMBODIMENTS OF THE INVENTION

In accordance with an aspect of the instant invention there is provided a method comprising providing a digital lending library for lending ebooks to end users for a limited time period; providing to the digital lending library information about a first end user, the information relating to at least a preference of the first end user; suggesting by the digital lending library to the first end user to one of borrow and purchase a target ebook in response to the determined at least a preference.

In accordance with an aspect of the instant invention there is provided a method comprising: providing a digital lending library for lending ebooks to end users for a limited time period; loaning from the digital library to a first end user a first ebook for a limited time period; providing to the digital lending library information about reading of the first ebook by the first end user, the information for use in determining at least a preference of the first end user; determining at least a preference in dependence upon the information; and suggesting by the digital lending library to the first end user to one of borrow and purchase a target ebook in response to the determined at least a preference.

### BRIEF DESCRIPTION OF THE DRAWINGS

Exemplary embodiments of the invention will now be described in conjunction with the following drawings, in which:

FIG. 1 is a simplified block diagram showing a system according to an embodiment of the instant invention;

FIG. 2 is a simplified flow diagram showing a method according to an embodiment of the instant invention;

FIG. 3 is a simplified flow diagram showing a method according to an embodiment of the instant invention;

FIG. 4 is a simplified flow diagram showing a method according to an embodiment of the instant invention.

FIG. 5 is a simplified flow diagram showing a method according to an embodiment of the instant invention;

FIG. 6 is a simplified flow diagram showing a method for providing access to an e-book based on time-slicing of a lending license associated therewith, according to an embodiment of the instant invention;

FIG. 7 is a simplified flow diagram of a method for enabling time slicing of a lending license, according to an embodiment of the instant invention;

FIG. 8 is a simplified flow diagram of a method for enabling time slicing of a lending license, according to an embodiment of the instant invention;

FIG. 9 is a simplified flow diagram of a method for enabling time slicing of a lending license, according to an embodiment of the instant invention;

FIG. 10 is a simplified flow diagram showing a method according to an embodiment of the instant invention;

FIG. 11 is a simplified flow diagram of a method for enabling time slicing of a lending license, according to an embodiment of the instant invention;

FIG. 12 is a simplified flow diagram of a method for enabling time slicing of a lending license, according to an embodiment of the instant invention; and,

FIG. 13 is a simplified flow diagram of a method for enabling time slicing of a lending license, according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

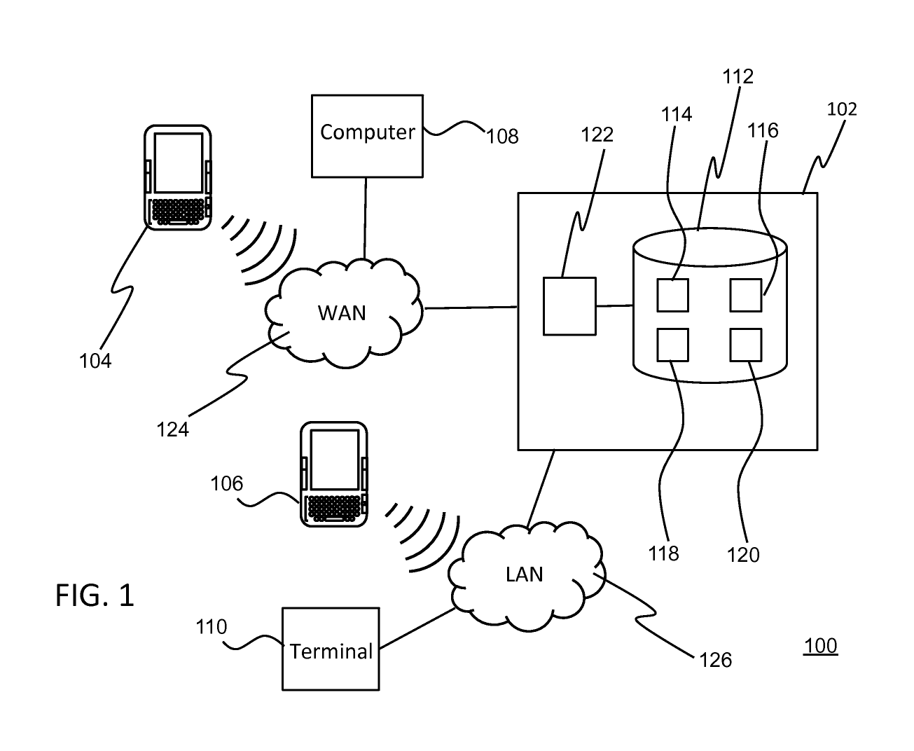

Referring to FIG. 1, shown is a simplified block diagram of a system 100 according to an embodiment of the instant invention. System 100 includes an e-book lending library 102 and a plurality of user devices including portable electronic devices 104 and 106, personal computer 108, and terminal 110. The e-book lending library 102 further includes a data storage system 112 for storing: e-book content 114; e-book lending licenses 116; e-book purchase licenses 118; and, library patron data 120. Additionally, the e-book lending library 102 includes a processor 122 having in execution thereon at least a process for controlling functions of the e-book lending library 102. Optionally, the data storage system 112 comprises a plurality of separate data storage devices (not shown) for storing the e-book content 114, the e-book lending licenses 116, the e-book purchase licenses 118, and the library patron data 120.

During use an e-book that is requested by a user is provided to the portable electronic device 104 or to the computer 108 via a wide area network (WAN) 124, such as for instance the Internet, or is provided to the portable electronic device 106 or to the terminal 110 via local area network 126. A registered patron may access the e-book lending library 102 via WAN 124 using the portable electronic device 104 or the computer 108 from virtually anywhere that an Internet connection is available.

Additionally, portable electronic device 104 optionally connects to WAN 124 via a WI-FI network, via Bluetooth, or via a cellular network. On the other hand, the registered patron must be present in an actual library branch in order to access the e-book lending library 102 via LAN 126 using the portable electronic device 106 or the terminal 110. The portable electronic device 106 may connect to LAN 126 via a WI-FI network, via a WI-FI access point, or via Bluetooth within the library branch.

When assessing preferences of a user of the portable electronic device, contiguous reading periods are often an indicator of interest. For example, it is often the case that long periods of uninterrupted reading indicate an interest in a particular ebook. Thus, such an ebook is indicated as being preferred. Similarly, shorter intervals between reading of the ebook indicate a preference therefore. Of course, the terms long and shorter are relative to other behaviours of the user, reading periods and intervals for other ebooks.

Advantageously, suggestions are provided to the user when they have completed an ebook. Alternatively, they are provided while the user is reading an ebook in advance of finishing the ebook. The suggestions are optionally provided at times unrelated to reading of the ebook or another ebook, but instead at times relating to a release of an ebook. For example, when it is determined that a user enjoys a series of ebooks, release of a next ebook in the series optionally motivates the system to suggest the next ebook proximate its release date. Thus the user is automatically reminded of ebooks of interest as they are released based on their automatically determined or manually provided user preferences.

Optionally, assessments of user preferences for both digital library ebooks and purchased ebooks are amalgamated into a single reader preference. Alternatively, the preferences relating to digital library ebooks are maintained separately from preferences relating to purchased ebooks.

Another use of the user preference data is in market research. User preference data when collected and anonymized is useful to indicate portions of an ebook that are more or less interesting, where readers are having trouble or losing interest, how fast people read a particular ebook and whether they could “put it down.”

Referring still to FIG. 1, the e-book lending library 102 includes at least one “instance” of each of a plurality of different e-books. In particular, each e-book that is stored in e-book content 114 of data storage system 112 is associated with at least one lending license that is stored in e-book lending licenses 116 of data storage system 112. By way of a specific and non-limiting example, a separate lending license is required for each e-book instance. In this case, the e-book lending library 102 is required to purchase three separate lending licenses for a first e-book in order to be authorized to lend three instances of the first e-book during overlapping periods of time. When all three lending licenses have been provided to different users, then the first e-book is unavailable temporarily for being loaned. Since the number of lending licenses associated with the first e-book is limited, a user must wait for one of the three instances of the first e-book to be “returned” to the e-book lending library 102 before they are able to borrow the first e-book. Generally, an e-book is loaned to a patron for a predetermined finite period of time—the loan period—such as for instance 14 days or 21 days, although any arbitrary loan period may be defined. On the other hand, the number of purchase licenses that are stored in e-book purchase licenses 118 of data storage system 112 may or may not be limited.

Operation of the system that is shown in FIG. 1 will now be described by way of a specific and non-limiting example, in which a user uses the portable electronic device 104 to access the e-book lending library 102 via WAN 124. In particular, the user provides a request message via a data input portion of the portable electronic device 104. The request message includes an indication of a first e-book that the user wishes to borrow from the e-book lending library 102, as well as user identification information for authenticating the user to the e-book lending library 102, such as for instance at least two of a library card number, a user name, and a password. According to one embodiment, a plurality of different e-book selections is displayed to the user via a display portion of the portable electronic device 104. For instance, a plurality of icons, each icon representing a different e-book selection, is displayed via a touch-sensitive screen portion of the portable electronic device 104. The icons are human intelligible, such as for instance an image of the cover art of an e-book that is represented by the e-book selection. In general, an e-book selection is a menu item representing an e-book that is stored in the e-book lending library 102, and it is selectable by the user for initiating a request to borrow the e-book that is represented by the e-book selection. In this example, the user may provide an indication for selecting one of the displayed e-book selections simply by touching the touch-sensitive screen of the portable electronic device 104. Optionally, the e-book selection is displayed in another human intelligible form, such as for instance the text of the title of the e-book that is represented by the e-book selection.

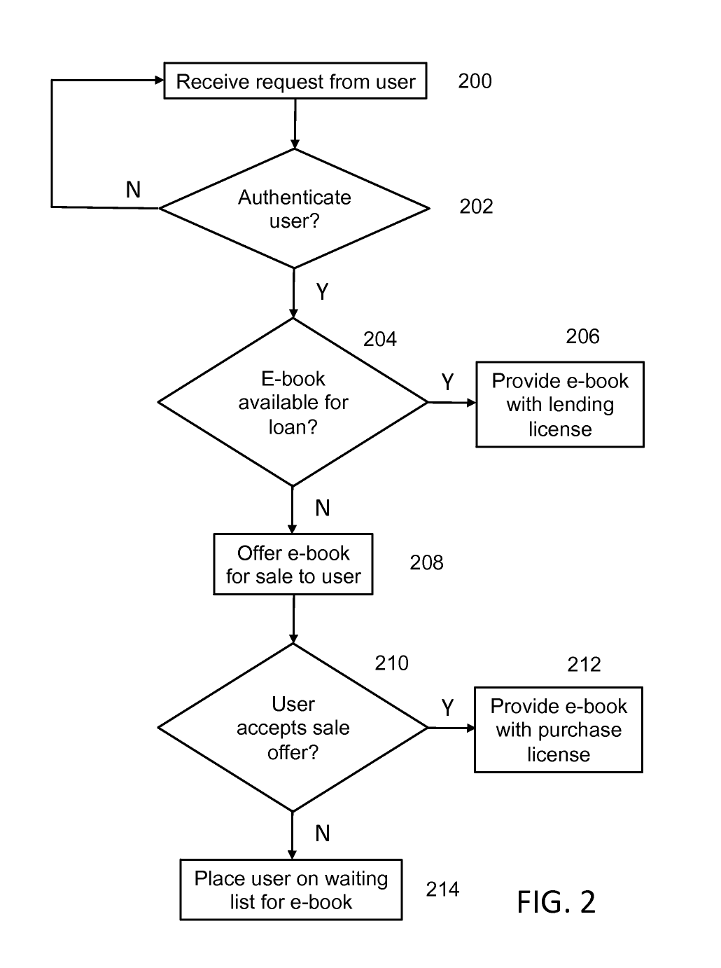

Now referring also to FIG. 2, at 200 the request message is transmitted from the portable electronic device 104 to the processor 122 of the e-book lending library 102 via WAN 124. At 202 a process in execution on the processor 122 extracts the user identification information from the request message, and compares it with library patron data 120 that is stored in data storage system 112. When the user is authenticated successfully as a registered patron, then a process in execution on the processor 122 is enabled for processing e-book loan requests from the user and for providing requested e-books from the e-book lending library 102 to the portable electronic device 104. For instance, a process that is in execution on the processor 122 extracts e-book loan request information from the request message that was received at 200. In the instant example, the e-book loan request information includes an indication of the first e-book. At 204 a process in execution on the processor 122 determines a current lending status of the first e-book as either available for lending or unavailable for lending. If it is determined at 204 that the first e-book is currently available for being loaned, then at 206 a lending license for the first e-book is retrieved from storage system 112 and is provided with the first e-book to the portable electronic device 104 via WAN 124. When it is determined that the first e-book is currently unavailable for being loaned, then at 208 a process in execution on the processor 122 offers to the user an opportunity to purchase the first e-book via the e-book lending library. If the user accepts the offer at 210, then at 212 a purchase license for the first e-book is retrieved from storage system 112 and is provided with the first e-book to the portable electronic device 104 via WAN 124. On the other hand, if the user declines the offer at 210 then at 214 the user is placed on a waiting list for the first e-book.

Optionally, the request to borrow e-books from the e-book lending library 102 is transmitted separately from the portable electronic device 104, subsequent to the user being authenticated as a registered patron. In this optional implementation, the request that is transmitted at 200 includes the user identification information but it does not include a request to borrow a specific e-book.

Optionally, the user is given the opportunity to purchase the first e-book either for personal use, as a gift, or to be donated to the e-book lending library 102. When the user purchases the first e-book for personal use, the first e-book and a purchase license for the first e-book are downloaded to an electronic device associated with the user as described above. When the user purchases the first e-book to be donated to the e-book lending library 102, one additional instance of the first e-book is added to the e-book lending library 102. By way of a specific and non-limiting example, one additional lending license for the first e-book is stored in data storage system 112. Optionally, the user is granted the privilege of borrowing the first e-book immediately using the one additional lending license, either for a predetermined finite period of time or for a period of time exceeding the established e-book lending period. Once the user “returns” the first e-book, then the additional instance of the first e-book is available to be loaned to any other patron that requests the first e-book subsequently. Optionally, the user is billed differently for the purchase of the first e-book in dependence upon whether the first e-book is purchased for personal use or to be donated to the e-book lending library 102. For instance, a premium of 300% to 400% is charged when the first e-book is purchased for being donated to the e-book lending library 102.

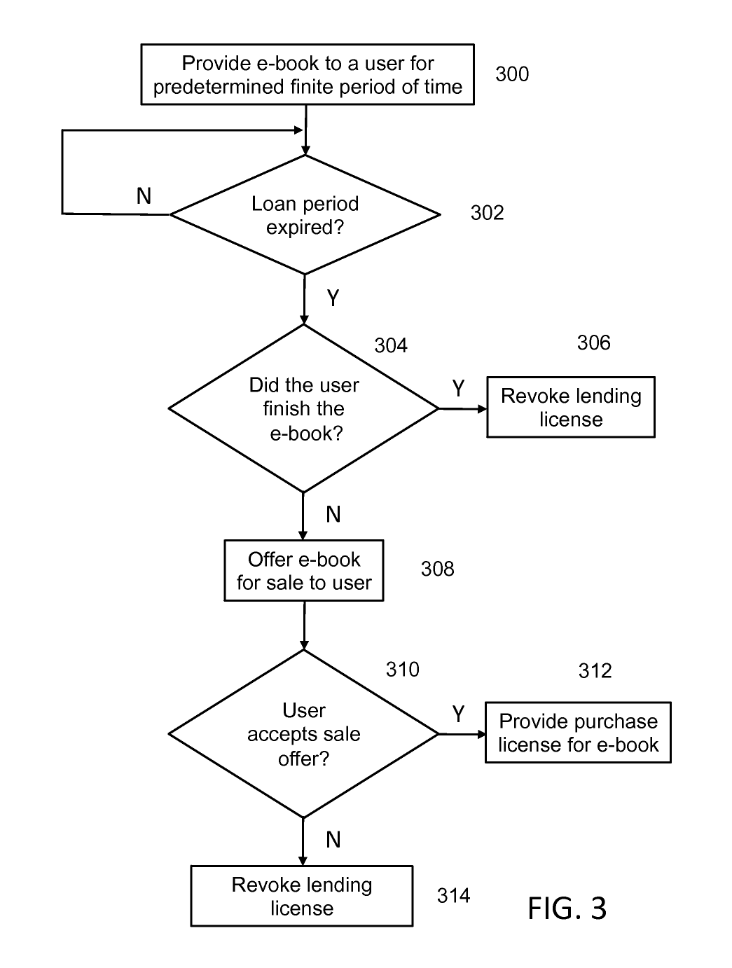

Referring now to FIG. 3, shown is a simplified flow diagram of a method according to another embodiment of the instant invention. The method of FIG. 3 is initiated at 300 when a user borrows a first e-book from the e-book lending library 102. In particular, the first e-book is loaned to the user for a predetermined finite period of time. When it is determined at 302 that the loan period for the first e-book has expired, then at 304 a determination is made automatically as to the user's reading progress through the first e-book. If it is determined that the user has finished reading the first e-book, then at 306 the lending license is revoked and the first e-book is “returned” automatically to the e-book lending library 102. On the other hand, if it is determined that the user has other than finished reading the first e-book, then at 308 the user is offered an opportunity to purchase the first e-book via the e-book lending library. If the user accepts the offer at 310, then at 312 a purchase license for the first e-book is retrieved from storage system 112 and is provided to the portable electronic device 104 via WAN 124. On the other hand, if the user declines the offer at 310 then at 314 the lending license is revoked and the first e-book is “returned” automatically to the e-book lending library 102.

Optionally, the user is given the opportunity to purchase the first e-book for personal use, as a gift, or to be donated to the e-book lending library 102. When the user purchases the first e-book for personal use, a purchase license for the first e-book is downloaded to an electronic device associated with the user as described above. When the user purchases the first e-book to be donated to the e-book lending library 102, one additional instance of the first e-book is added to the e-book lending library 102. By way of a specific and non-limiting example, one additional lending license for the first e-book is stored in data storage system 112. Optionally, the user is granted the privilege of borrowing the first e-book immediately using the one additional lending license, either for a predetermined finite period of time or for a period of time exceeding the established e-book lending period. The lending license currently associated with the first e-book is returned to the e-book lending library 102 and is available for use by another user. Thus, the user may complete the first e-book even if another user has placed a hold on the first e-book. Once the first e-book is “returned,” then the additional instance of the first e-book is available to be loaned to any other patron that requests the first e-book subsequently. Optionally, the user is billed differently for the purchase of the first e-book in dependence upon whether the first e-book is purchased for personal use or to be donated to the e-book lending library 102. For instance, a premium of 300% to 400% is charged when the first e-book is purchased for being donated to the e-book lending library 102.

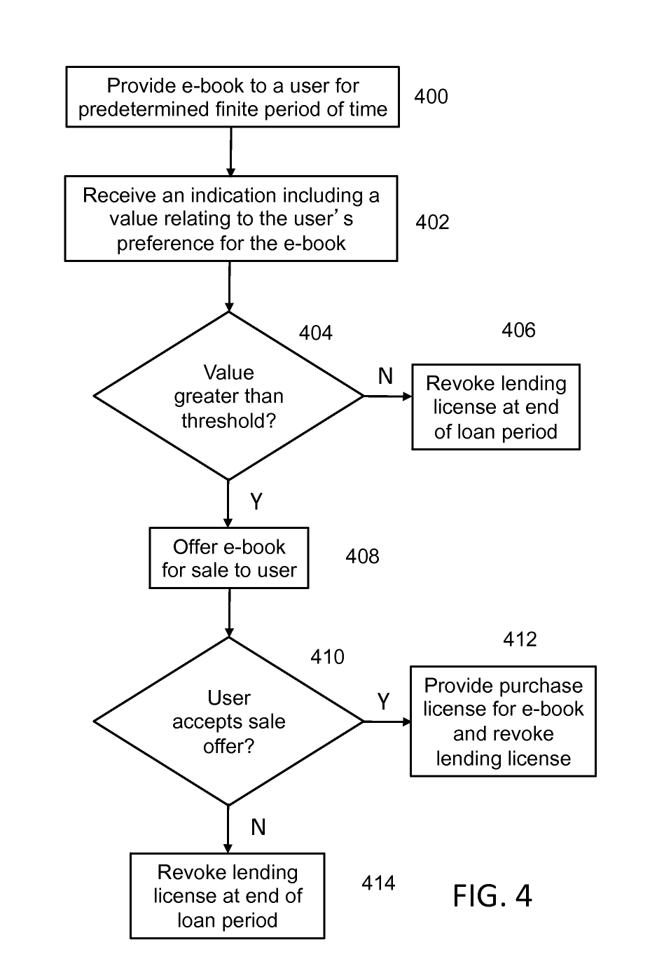

Referring now to FIG. 4, shown is a simplified flow diagram of a method according to another embodiment of the instant invention. The method of FIG. 4 is initiated at 400 when a user borrows a first e-book from the e-book lending library 102. In particular, the first e-book is loaned to the user for a predetermined finite period of time—the loan period—such as for instance 14 days or 21 days. At 402, some time after the first e-book is loaned to the user, a signal is received at the e-book lending library. For instance, the signal is provided to the e-book lending library 102 from the portable electronic device 104 via WAN 124, in either an automated or a manual fashion. The signal includes a value relating to the user's preference for the first e-book. For instance, the value is indicative of a user rating of 4 on a scale from 0 to 5. At 404 it is determined if the value is greater than a predetermined threshold value. If the value is not greater than the predetermined threshold value then at 406 the lending license for the first e-book is revoked at the end of the loan period and the first e-book is returned automatically to the e-book lending library. If the value is greater than the predetermined threshold value then at 408 the user is offered an opportunity to purchase the first e-book via the e-book lending library. If the user accepts the offer at 410, then at 412 a purchase license for the first e-book is retrieved from storage system 112 and is provided to the portable electronic device 104 via WAN 124. The lending license is revoked at the same time the purchase license is provided. On the other hand, if the user declines the offer at 410 then at 414 the lending license is revoked at the end of the loan period, and the first e-book is “returned” automatically to the e-book lending library 102.

Optionally, the signal is provided to the e-book lending library 102 from the portable electronic device 104 via WAN 124 upon expiration of the predetermined finite period of time. This may be performed automatically by generating a value on the basis of information that is collected by the portable electronic device 104 as the user is reading the first e-book. For instance, the speed or constancy with which the user reads the first e-book may be used to infer a stronger preference for the first e-book, therefore resulting in a high value, whilst slow progress or long gaps between reading sessions may be used to infer a weaker preference for the first e-book, therefore resulting in a relatively lower value. Alternatively, the value is generated based on one or more ratings that are provided by the user, in which case the signal is transmitted either in an automated or a manual fashion. Further alternatively, the value is generated based on ratings that are provided by contacts associated with the user. For instance, if the user's family members have read the first e-book and provided ratings, then a value relating to the user's preference may be inferred based on the family members' ratings. In this case, the signal is transmitted to the e-book lending library from devices that are associated with other than the user. Optionally, the family member's ratings are weighted based on similarities to the user's ratings for a set of other e-books.

Alternatively, the converse is also possible. That is to say, in an e-book store when it is determined that a requested e-book is available for being loaned from an e-book lending library, a user is offered an opportunity to borrow the e-book from the e-book lending library instead of buying it from the e-book store.

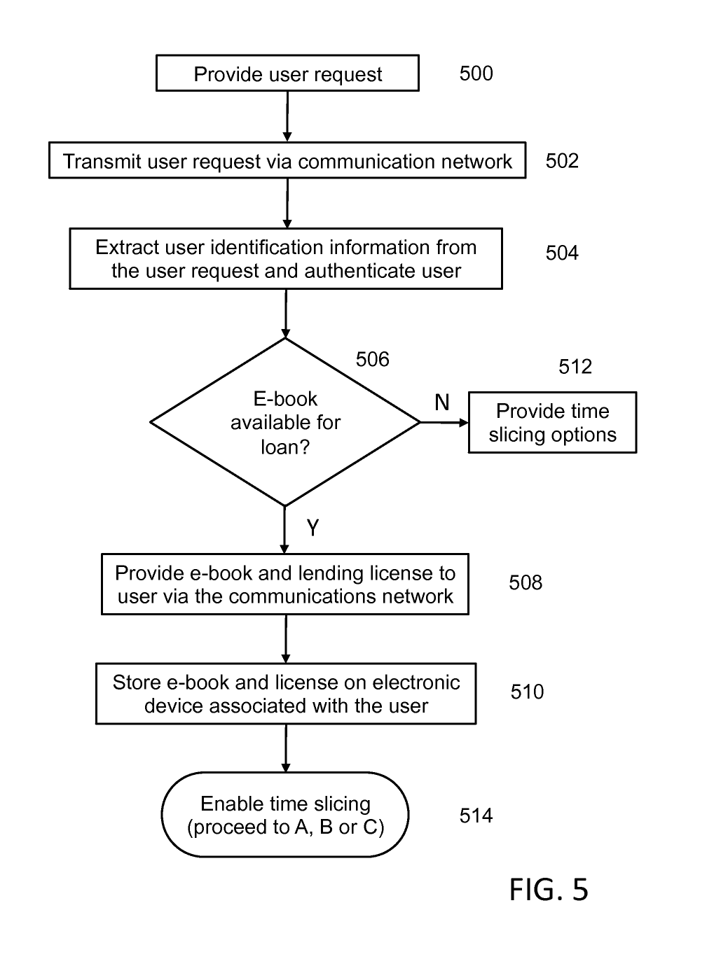

Referring now to FIG. 5, shown is a simplified flow diagram of a method according to an embodiment of the instant invention. In this specific and non-limiting example a user uses the portable electronic device 104 to access the e-book lending library 102 via WAN 124. In particular, at 500 the user provides a request via a data input portion of the portable electronic device 104. The request includes an indication of a first e-book that the user wishes to borrow from the e-book lending library 102, as well as user identification information for authenticating the user to the e-book lending library 102, such as for instance at least two of a library card number, a user name, and a password. In an embodiment, a plurality of different e-book selections is displayed to the user via a display portion of the portable electronic device 104. For instance, a plurality of icons, each icon representing a different e-book selection, is displayed via a touch-sensitive screen portion of the portable electronic device 104. The icons are human intelligible, such as for instance an image of the cover art of an e-book that is represented by the e-book selection. In general, an e-book selection is a menu item representing an e-book that is stored in the e-book lending library 102, and it is selectable by the user for initiating a request to borrow the e-book that is represented by the e-book selection. The user may provide an indication for selecting one of the displayed e-book selections simply by touching the touch-sensitive screen of the portable electronic device 104. Optionally, the e-book selection is displayed in another human intelligible form, such as for instance as the text of the title of the e-book that is represented by the e-book selection.

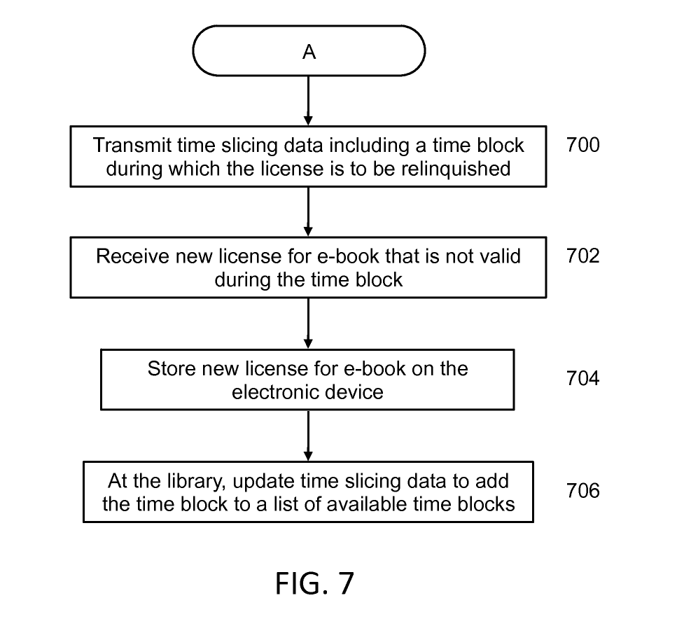

At 502 the request is transmitted from the portable electronic device 104 to the processor 122 of the e-book lending library 102 via WAN 124. At 504 a process in execution on the processor 122 extracts the user identification information from the request message, and compares it with library patron data 120 that is stored in data storage system 112. When the user is authenticated successfully at 504 as a registered patron, then a process in execution on the processor 122 is enabled for processing at 506 e-book loan requests from the user, and for providing at 508 the requested e-books from the e-book lending library 102 to the portable electronic device 104. For instance, a process that is in execution on the processor 122 extracts e-book loan request information from the request message. In the instant example, the e-book loan request information includes an indication of the first e-book. A process in execution on the processor 122 determines at 506 a current lending status of the first e-book as either available for lending or unavailable for lending. If it is determined that the first e-book is currently available for being loaned, then at 508 a lending license for the first e-book is retrieved from storage system 112 and is provided with the first e-book to the portable electronic device 104 via WAN 124. Once the first e-book and the lending license associated therewith are received and stored on the portable electronic device 104 at 510, the user is able to view the first e-book via a display portion of the portable electronic device 104, until the end of the loan period. At 514 the user enables time slicing of the lending license, so as to allow another user to have access to the first e-book prior to the end of the loan period. As is discussed in more detail below with reference to FIGS. 7-9, the user defines a time block during which the lending license is to be relinquished by the user so that it may be made available to another user. Typically, the time block is short relative to the loan period, such as for instance several hours. The time block optionally reoccurs at a defined interval, such as for instance daily, or is a one-time occurrence. Optionally, the user “schedules” a plurality of time blocks based on their expected routine during the loan period.

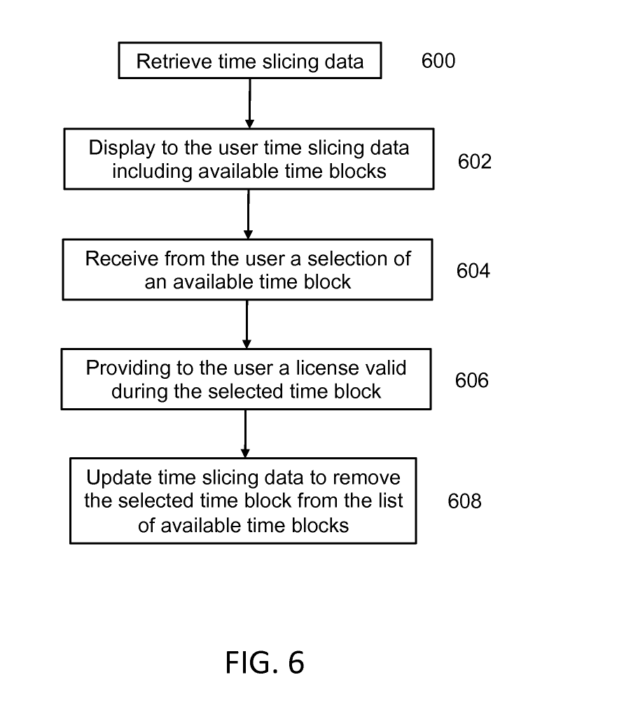

Alternatively, if it is determined at 506 that the first e-book is not currently available for being loaned, then at 512 the user is provided an opportunity to obtain access to the first e-book based on time-slicing of the lending license. Referring also to FIG. 6, a process in execution on the processor 122 retrieves time slicing data 118 from data storage system 112 at 600, including an indication of time blocks during which the lending license for the first e-book has been made available by another user. At 302 the time slicing data 118 are transmitted to the user via WAN 124 and displayed via the display portion of portable electronic device 104. At 604, the process in execution on the processor 122 receives from the user a selection of an available time block. At 606 the process in execution on the processor 122 provides a lending license to the user via the WAN 124. In particular, the provided lending license is valid during the selected time block but it is not valid outside of the selected time block. At 608, the process in execution on the processor 122 updates the time slicing data stored on data storage system 112 to delete the selected time block from the list of available time blocks.

Using the lending license that is provided in accordance with the method of FIG. 6, the user is able to view and otherwise utilize the first e-book in a normal manner during the selected time block. Prior to the start of the selected time block and subsequent to the end of the selected time block, the user is prevented from accessing the first e-book. In addition, another user that has agreed to relinquish the lending license during the selected time block is prevented from accessing the first e-book during the selected time block. In this way, only one user at a time is permitted to access the first e-book using a single lending license. That being said, the first e-book is utilized by a plurality of users during a greater portion of the loan period than would be the case if only a single user had access to the e-book. Additionally, when the lending library has a plurality of instances of the first e-book, a user may attempt to “string together” substantially continuous access to the first e-book based on time-sliced lending licenses for the plurality of instances of the first e-book.

Referring now to FIG. 7, shown is a method of enabling time slicing of a lending license according to an embodiment of the instant invention. For instance, the method of FIG. 7 is performed at step 514 of the method of FIG. 5 after the user has stored the first e-book and the lending license associated therewith on portable electronic device 104. At 700 the user transmits time slicing data from portable electronic device 104 to the e-book lending library 102 via WAN 124, the time slicing data including an indication of a time block during which the user agrees to relinquish the lending license for use by another user. By way of a specific and non-limiting example, the user wishes to set aside the time between 11:00 pm and 8:00 am for sleeping, relaxation, socializing etc. The user defines a reoccurring time block with a start time of 11:00 pm and an end time of 8:00 am, and an indication of the reoccurring time block is transmitted via WAN 124 to a process in execution on the processor 122. In response, at 702 the process in execution on the processor 122 transmits to the user via WAN 124 a new lending license for the first e-book. In particular, the new lending license is not valid during the reoccurring time block. At 704 the new lending license is stored on the portable electronic device 104 in place of the original lending license that was provided at 508. Finally, at 706 the process in execution on the processor 122 updates the time slicing data 118 that is stored on data storage system 112. The updated time slicing data identifies the lending license as being available for use by another user during the time block. Of course the user is prevented from accessing the first e-book during the time block, regardless of whether or not the lending license actually is provided to another user, since the new lending license that is stored at 704 is not valid during the time block.

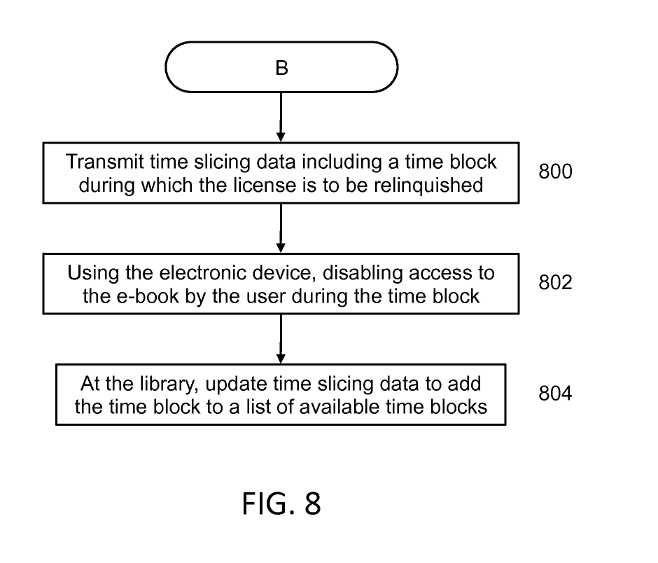

Referring now to FIG. 8, shown is another method of enabling time slicing of a lending license according to an embodiment of the instant invention. For instance, the method of FIG. 8 is performed at step 514 of the method of FIG. 5 after the user has stored the first e-book and the lending license associated therewith on portable electronic device 104. At 800 the user transmits time slicing data to the e-book lending library 102 via WAN 124, the time slicing data including a time block during which the user agrees to relinquish the lending license for use by another user. By way of a specific and non-limiting example, the user wishes to set aside the time between 11:00 pm and 8:00 am for sleeping, relaxation, socializing etc. The user defines a reoccurring time block with a start time of 11:00 pm and an end time of 8:00 am, which is transmitted via WAN 124 to a process in execution on the processor 122. At 802, the portable electronic device 104 disables access to the e-book by the user during the time block. For instance, the portable electronic device includes a clock circuit for providing a clock signal and a processor responsive to the clock signal for controlling access to the first e-book. When the clock signal indicates that the time is 11:00 pm, in this specific and non-limiting example, a process in execution on the processor disables access to the first e-book. Similarly, when the clock signal indicates that the time is 8:00 am, again in this specific and non-limiting example, the process in execution on the processor enables access to the first e-book. At 804 the process in execution on the processor 122 updates the time slicing data 118 that is stored on data storage system 112. The updated time slicing data identifies the lending license as being available for use by another user during the time block.

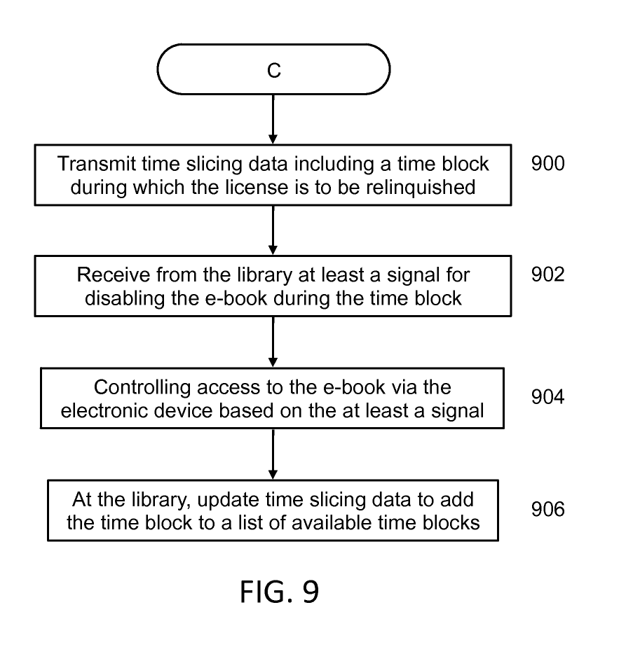

Referring now to FIG. 9, shown is a method of enabling time slicing of a lending license according to an embodiment of the instant invention. For instance, the method of FIG. 9 is performed at step 514 of the method of FIG. 5. At 900 the user transmits time slicing data to the e-book lending library via WAN 124, the time slicing data including a time block during which the user agrees to relinquish the lending license for use by another user. By way of a specific and non-limiting example, the user wishes to set aside the time between 11:00 pm and 8:00 am for sleeping, relaxation, socializing etc. The user defines a reoccurring time block with a start time of 11:00 pm and an end time of 8:00 am, which is transmitted to via WAN 124 to a process in execution on the processor 122. In response, at the start of the time block the process in execution on the processor 122 transmits to the user via WAN 124 at least a signal for disabling access to the first e-book via the portable electronic device 104 during the reoccurring time block. At 904 access to the first e-book is controlled based on the at least a signal. For instance, when the portable electronic device 104 is connected to WAN 124 and receives the at least a signal either at or before the start of the time block, then access to the first e-book is disabled and a confirmation is transmitted back to the e-book lending library 102. In an embodiment, the at least a signal includes one of a duration of the time block and an absolute time for defining the end of the time block. Accordingly, based on the at least a signal, once access to the first e-book is disabled, the user must wait until the defined end of the time block to access the e-book. Finally, at 906 the process in execution on the processor 122 updates the time slicing data 118 that is stored on data storage system 112. The updated time slicing data identifies the lending license as being available for use by another user during the time block.

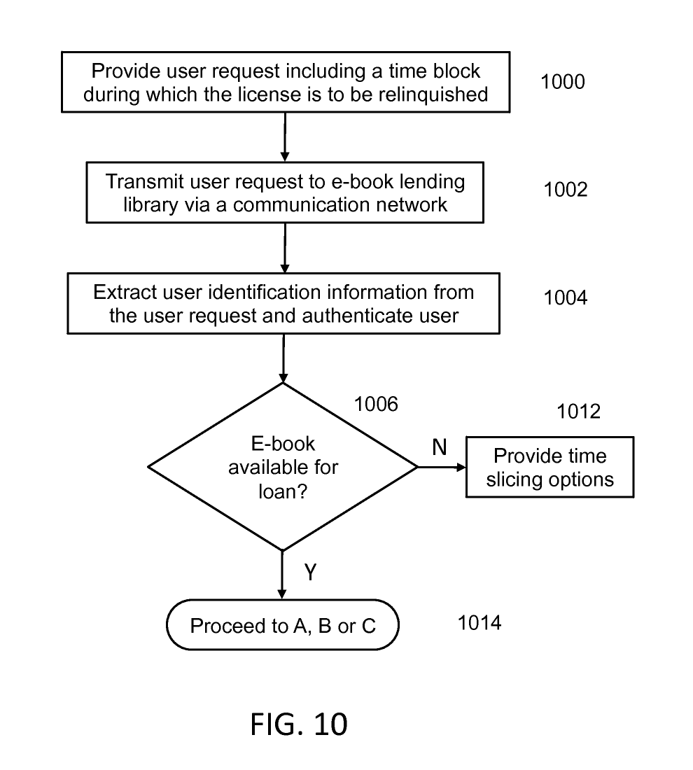

Referring now to FIG. 10, shown is a simplified flow diagram of a method according to an embodiment of the instant invention. In this specific and non-limiting example a user uses the portable electronic device 104 to access the e-book lending library 102 via WAN 124. In particular, at 1000 the user provides a request via a data input portion of the portable electronic device 104. The request includes an indication of a first e-book that the user wishes to borrow from the e-book lending library 102, as well as user identification information for authenticating the user to the e-book lending library 102, such as for instance at least two of a library card number, a user name, and a password. In an embodiment, a plurality of different e-book selections is displayed to the user via a display portion of the portable electronic device 104. For instance, a plurality of icons, each icon representing a different e-book selection, is displayed via a touch-sensitive screen portion of the portable electronic device 104. The icons are human intelligible, such as for instance an image of the cover art of an e-book that is represented by the e-book selection. In general, an e-book selection is a menu item representing an e-book that is stored in the e-book lending library 102, and it is selectable by the user for initiating a request to borrow the e-book that is represented by the e-book selection. The user may provide an indication for selecting one of the displayed e-book selections simply by touching the touch-sensitive screen of the portable electronic device 104. Optionally, the e-book selection is displayed in another human intelligible form, such as for instance as the text of the title of the e-book that is represented by the e-book selection.

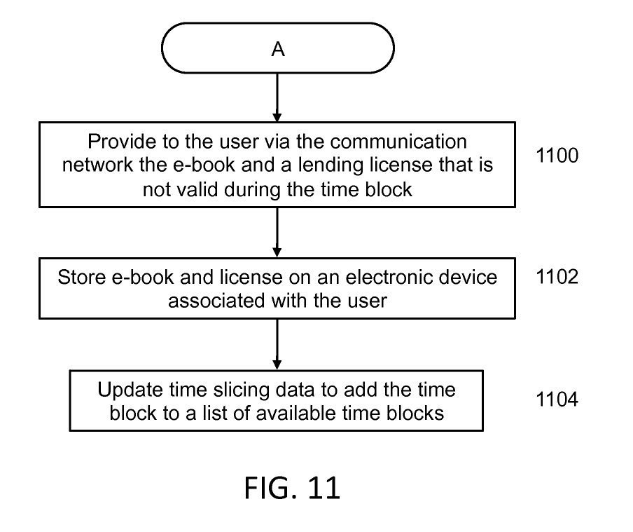

Referring still to FIG. 10, the request that is provided by the user at 1000 further includes time slicing data, including a time block during which the user agrees to relinquish the lending license for use by another user. By way of a specific and non-limiting example, the user wishes to set aside the time between 11:00 pm and 8:00 am for sleeping, relaxation, socializing etc. The user defines a reoccurring time block with a start time of 11:00 pm and an end time of 8:00 am, which is transmitted via WAN 124 to a process in execution on the processor 122. At 1002 the request including the time slicing data is transmitted from the portable electronic device 104 to the processor 122 of the e-book lending library 102 via WAN 124. At 1004 a process in execution on the processor 122 extracts the user identification information from the request message, and compares it with library patron data 120 that is stored in data storage system 112. When the user is authenticated successfully at 1004 as a registered patron, then a process in execution on the processor 122 is enabled for processing at 1006 e-book loan requests from the user. For instance, a process that is in execution on the processor 122 extracts e-book loan request information from the request message. In the instant example, the e-book loan request information includes an indication of the first e-book. A process in execution on the processor 122 determines at 1006 a current lending status of the first e-book as either available for lending or unavailable for lending. If it is determined that the first e-book is currently available for being loaned, then at 1014 the first e-book is provided to the user and time slicing is enabled, as is described below in greater detail with reference to FIGS. 11-13.

Alternatively, if it is determined at 1006 that the first e-book is not currently available for being loaned, then at 1012 the user is provided an opportunity to obtain access to the e-book based on time-slicing of the lending license. Referring again to FIG. 6, a process in execution on the processor 122 retrieves time slicing data 118 from data storage system 112 at 600, including time blocks during which the lending license for the first e-book is available. At 602 the time slicing data 118 are transmitted to the user via WAN 124 and displayed via the display portion of portable electronic device 104. At 604, the process in execution on the processor 122 receives from the user a selection of an available time block. At 606 the process in execution on the processor 122 provides a lending license to the user via the WAN 124. In particular, the provided lending license is valid during the selected time block but it is not valid outside of the selected time block. At 608, the process in execution on the processor 122 updates the time slicing data stored on data storage system 112 to delete the selected time block from the list of available time blocks.

Using the lending license that is provided according to the method of FIG. 6, the user is able to view and otherwise utilize the first e-book in a normal manner during the selected time block. Prior to the start of the selected time block and subsequent to the end of the selected time block, the user is prevented from accessing the first e-book. In addition, another user that has agreed to relinquish the lending license during the selected time block is prevented from accessing the first e-book during the selected time block. In this way, only one user at a time is permitted to access the first e-book using a single lending license. That being said, the first e-book is utilized by a plurality of users during a greater portion of the loan period than would be the case if only a single user had access to the first e-book. Additionally, when the lending library has a plurality of instances of the first e-book, a user may attempt to “string together” substantially continuous access to the first e-book based on time-sliced lending licenses for the plurality of instances of the first e-book.

Referring now to FIG. 11, shown is a method of providing a requested e-book to a user and enabling time slicing of a lending license associated with the e-book, according to an embodiment of the instant invention. For instance, the method of FIG. 11 is performed at step 1014 of the method of FIG. 10. At 1100 the e-book lending library provides to the user via the WAN 124 the first e-book and a lending license associated therewith. In particular, the lending license is not valid during the time block that was specified in the user request at 1000. At 1102 the user stores the first e-book and the lending license on portable electronic device 104. At 1104 a process in execution on the processor 122 updates the time slicing data stored on data storage system 112 to add the selected time block to a list of available time blocks associated with the first e-book. The updated time slicing data identifies the lending license as being available for use by another user during the time block. Of course the user is prevented from accessing the first e-book during the time block, regardless of whether or not the lending license actually is provided to another user, since the lending license that is stored at 802 is not valid during the time block.

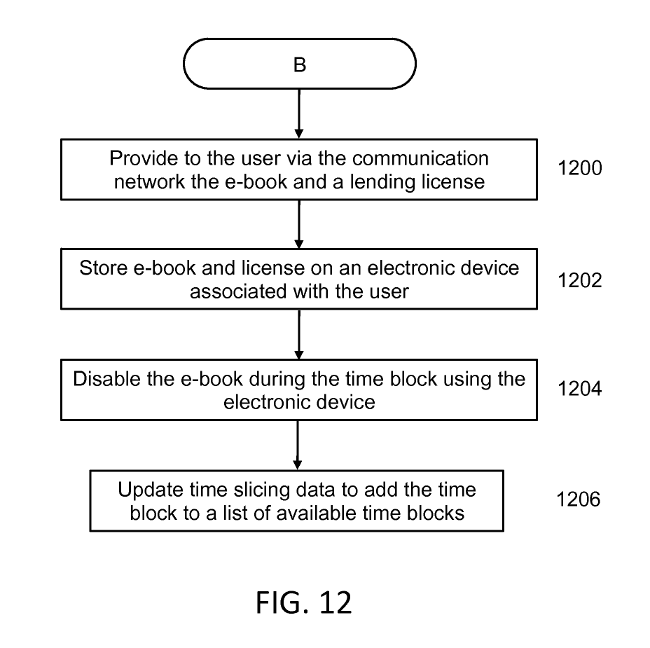

Referring now to FIG. 12, shown is another method of providing a requested e-book to a user and enabling time slicing of a lending license associated with the e-book, according to an embodiment of the instant invention. For instance, the method of FIG. 12 is performed at step 1014 of the method of FIG. 10. At 1200 the e-book lending library provides to the user via the WAN 124 the first e-book and a lending license associated therewith. At 1202 the user stores the e-book and the lending license on portable electronic device 104. At 1204, the portable electronic device 104 disables access to the first e-book by the user during the time block. At 1206 the process in execution on the processor 122 updates the time slicing data 118 that is stored on data storage system 112. The updated time slicing data identifies the lending license as being available for use by another user during the time block. Optionally, the user may transmit a request to the e-book lending library to determine a status of the lending license during the time block. If the lending license is not assigned to another user already, then the portable electronic device 104 may unlock the first e-book so as to allow the user to access the first e-book during the time period. Of course, if the lending license is assigned to another user already, then the portable electronic device 104 cannot be unlocked, and the user must wait until the end of the time block to access the first e-book.

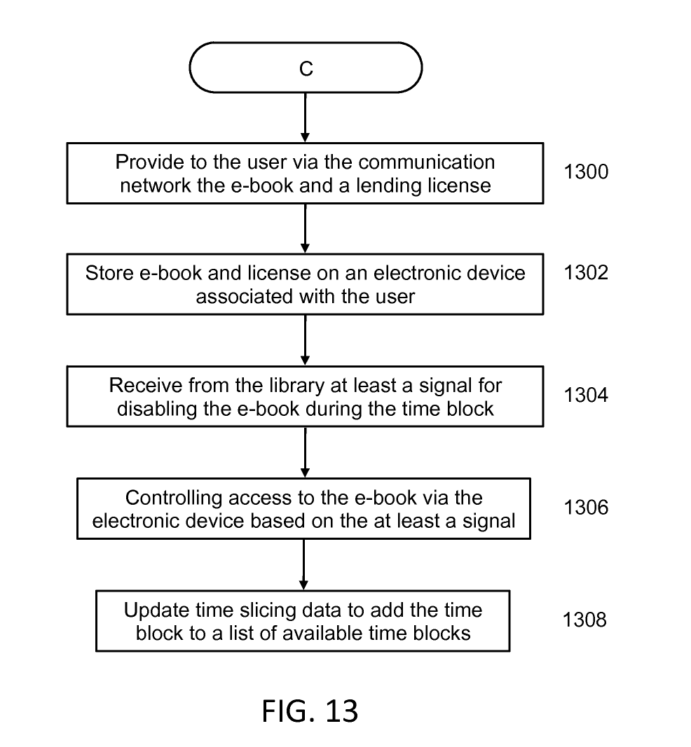

Referring now to FIG. 13, shown is a method of providing a requested e-book to a user and enabling time slicing of a lending license associated with the e-book, according to an embodiment of the instant invention. For instance, the method of FIG. 13 is performed at step 1014 of the method of FIG. 10. At 1300 the e-book lending library provides to the user via the WAN 124 the first e-book and a lending license associated therewith. At 1302 the user stores the first e-book and the lending license on portable electronic device 104. At 1304, corresponding to the start of the time block, the process in execution on the processor 122 transmits to the user via WAN 124 at least a signal for disabling access to the first e-book via the portable electronic device 104 during the time block. At 1306 access to the first e-book is controlled based on the at least a signal. For instance, when the portable electronic device 104 is connected to WAN 124 and receives the at least a signal at the start of the time block, then access to the first e-book is disabled and a confirmation is transmitted back to the e-book lending library. In an embodiment, the at least a signal includes one of a duration of the time block and an absolute time for defining the end of the time block. Accordingly, based on the at least a signal, once access to the e-book via 104 is disabled, the user must wait until the defined end of the time block to access the e-book. Finally, at 1308 the process in execution on the processor 122 updates the time slicing data 118 that is stored on data storage system 112.

The updated time slicing data identifies the lending license as being available for use by another user during the time block.

Alternatively, if a first user desires access to an e-book on an urgent basis, they indicate this to the digital library. In response, the digital library monitors the e-book usage to determine when a user is no longer using the e-book. For example, the digital library communicates with borrowers of the e-book to inform them that if they are not using the e-book, they can relinquish their rights to it for a time that they can specify.

When a user specifies a time block during which they will not access the e-book, a signal indicating same is provided to the digital library. A second signal is transmitted from the digital library to the electronic device of the first user to indicate an available time block. Optionally, the available time block starts at the present moment. The first user then accepts the time block and is provided access to the e-book when the time block starts—immediately when the time block starts at the present moment. In such a fashion, users who are willing to be inconvenienced and wait for an e-book, can be rewarded with earlier access thereto.

Some non-limiting examples of portable electronic devices 104 and 106 include notebook computers, netbooks/subnotebooks, personal digital assistants (PDAs), smart phones such as for instance the Apple® IPhone®, gaming devices such as for instance the Nintendo® DS, DS Lite or DSi, digital book readers such as for instance the Amazon Kindle 2, etc.

Numerous other embodiments may be envisaged without departing from the scope of the invention.

What is claimed is:

1. A method comprising:
providing a digital lending library for lending ebooks to end users for a limited time period;
providing to the digital lending library information about a first end user, the information relating to at least a preference of the first end user; and,
suggesting by the digital lending library to the first end user to one of borrow and purchase a target ebook in response to the determined at least a preference.

2. A method according to claim 1 comprising:
providing an indication of a reading speed for the first end user of a first ebook, wherein the at least a preference is determined in dependence upon the reading speed of the first end user of the first ebook.

3. A method according to claim 2 wherein the indication of the reading speed for the first end user comprises an indication of the reading speed relative to a reading speed for the first end user for other ebooks.

4. A method according to claim 3 wherein suggesting comprises suggesting to purchase an ebook.

5. A method according to claim 4 wherein suggesting is performed upon completion of reading of the first book.

6. A method according to claim 4 wherein suggesting is performed based upon a release date of the target ebook.

7. A method according to claim 1 comprising:
providing an indication of at least a contiguous reading period for the first end user of a first ebook, wherein the at least a preference is determined in dependence upon a length of the at least a contiguous period of the first end user of the first ebook.

8. A method according to claim 7 wherein the indication of at least a contiguous reading period for the first end user comprises an indication of the at least a contiguous reading period relative to at least a contiguous reading period for the first end user for other ebooks.

9. A method according to claim 8 wherein suggesting comprises suggesting to purchase an ebook.

10. A method according to claim 9 wherein suggesting is performed upon completion of reading of the first book.

11. A method according to claim 9 wherein suggesting is performed based upon a release date of the target ebook.

12. A method according to claim 1 wherein a first ebook is loaned to the first end user from the digital library for a first loan period, the method comprising:
providing an indication of completion of reading the first ebook during the first loan period, and wherein suggesting comprises:
when completion of reading of the first ebook has other than occurred, suggesting to the first end user to purchase the first ebook; and
when completion of reading of the first ebook has occurred, suggesting to the first end user to borrow a second other ebook.

13. A method according to claim 1 wherein a first ebook is loaned to the first end user from the digital library for a first loan period, the method comprising:
providing an indication of completion of reading the first ebook during the first loan period, and wherein suggesting comprises:
when completion of reading of the first ebook has other than occurred, suggesting to the first end user to purchase the first ebook; and
when completion of reading of the first ebook has occurred, suggesting to the first end user to purchase a second other ebook.

14. A method according to claim 1 comprising:
providing an indication of at least a gap between contiguous reading periods for the first end user of a first ebook, wherein the at least a preference is determined in dependence upon a length of the at least a gap of the first end user of the first ebook.

15. A method according to claim 14 wherein the indication of at least a gap reading comprises an indication of the at least a gap relative to at least a gap for the first end user for other ebooks.

16. A method according to claim 15 wherein suggesting comprises suggesting to purchase an ebook.

17. A method according to claim 16 wherein suggesting is performed upon completion of reading of the first book.

18. A method according to claim 16 wherein suggesting is performed based upon a release date of the target ebook.

19. A method comprising:
providing a digital lending library for lending ebooks to end users for a limited time period;
loaning from the digital library to a first end user a first ebook for a limited time period;
providing to the digital lending library information about reading of the first ebook by the first end user, the information for use in determining at least a preference of the first end user;
determining at least a preference in dependence upon the information; and,
suggesting by the digital lending library to the first end user to one of borrow and purchase a target ebook in response to the determined at least a preference.

20. A method according to claim 19 wherein suggesting comprises suggesting to the first user to purchase the target ebook.
